(19) United States
(12) Patent Application Publication
(10) Pub. No.: US 2014/0166147 A1
(43) Pub. Date: Jun. 19, 2014

(54) Multilayer Film

(71) Applicant: Buergofol GmbH, Siegenburg (DE)

(72) Inventor: Abdel-Kader Boutrid, Siegenburg (DE)

(73) Assignee: Buergofol GmbH, Siegenburg (DE)

(21) Appl. No.: 14/101,789

(22) Filed: Dec. 10, 2013

(30) Foreign Application Priority Data
Dec. 10, 2012 (DE) 10 2012 112 024.2

(51) Int. Cl. F16L 9/00

(52) U.S. Cl. CPC F16L 9/00
USPC 138/140

(57) ABSTRACT

The invention refers to a multilayered film, preferably in form of a tubular film, with a layer sequence made up of at least the following layers: At least one layer (1) containing at least one homo- and/or copolyamide, preferably as one of the external layers, at least one adhesive promoter layer (2), (4), and at least one additional layer (3), (5), preferably as one of the external layers. The multilayered film according to the invention is characterized by the fact that it contains in the at least one adhesive promoter layer (2), (4) and/or the at least one additional layer (3), (5) at least one ethylene(meth)acrylate copolymer, in functionalized or non-functionalized form. In addition, uses of such a multilayered film are presented as well as an insertion tube for trenchless sewage pipe renovation that includes such a multilayered film.

The invention refers to a multilayered film, preferably in the form of a tubular film, with a layer sequence made up of at least the following layers: A minimum of one layer containing at least one homo- and/or co-polyamide, preferably as one of the outer layers, at least one adhesive promoter layer and at least one more layer, preferably as one of the outer layers.

The area of application of films having an olefin homo or copolymer layer (such as a polyethylene (PE) layer) and a polyamide (PA) layer is very large. One of their fields of application is in the pipe lining process for trenchless sewage pipe renovation. Here, it is known from the glass fiber pipe liner system with UV or steam curing, for example, that a high density, thick-walled PE film (HDPE—high density polyethylene) needs to be inserted into the pipe to be renovated as a sliding film which is placed against the inner wall of the pipe—generally in the cross-sectional form of a half circle. Afterwards, a flexible insertion tube is inserted into the pipe (insertion process), in which case the insertion tube glides over the sliding film. As a result of this, first of all, damage to the insertion tube caused by the inner wall of the tube or objects inside the tube is prevented and secondly, the friction between the insertion tube and the sliding film is very low, which facilitates the retraction of the insertion tube.

In the glass fiber-pipe liner system cured with UV or steam, such an insertion tube (also known as pipe liner) typically has an outer tube (outer tube film) and an inner tube (inner tube film) with a carrier material (such as glass fibers) inserted between them that has been impregnated with reactive plastic resin. Some of the reactive plastic resins used are, for example, commercially available UP resins (polyester/unsaturated polyester resins), VE resins (vinyl ester resins) or EP resins (epoxy resins). For example, UP or VE resins are cured with the help of photoinitiators, but heat can also cure them. The insertion tube is inflated inside the pipe by the compressed air directed against the mechanically stable inner tube film from the inside until the outer tube film presses tightly against the inner wall of the pipe or the sliding film to subsequently cure the resin—for example by using UV light from a UV light source being pulled slowly along the interior of the inflated insertion tube. At the end, the inner tube film of the insertion tube is peeled off and removed. The layer with the carrier material is then exposed to the substances to be guided through the pipe.

To prevent unwanted premature curing of the plastic resin before insertion into the pipe to be renovated (particularly during storage), it is necessary for the outer tube film of the insertion tube to have or consist of a protective layer to prevent a premature effect of UV radiation or shorter-wave visible light radiation on the resin, causing its premature curing. On the other hand, the inner tube film of such an insertion tube must be highly transparent to UV radiation and shorter-wave visible light radiation. This makes it possible for the curing process to take place, carried out by a UV radiation source in the pipe liner inflated inside the pipe when it is pulled through the inner side of the pipe liner, i.e. inside the inner tube film.

In the synthetic fiber pipe liner system used in trenchless sewer pipe renovation, an additional tube can be used as so-called pre-liner or as reinforced or calibration hose with warm water or steam curing. A pre-liner covers the entire circumference of the pipe to be renovated, is laid tightly against it and inserted into the pipe either before the insertion tube or at the same time. The insertion tube is inserted either in the pre-liner (insertion process) or inversed in or with the pre-liner (inversion method, inside-out turning method).

One of the disadvantages of the PE/PA or PE/AP/PA film (AP: adhesive promoter) mentioned above, used currently as inner tube film, is its low mechanical strength. In a worst case scenario, the inner tube film's insufficient mechanical properties cause the film to burst when the inner tube film of the insertion tube (pipe liner) executed in the form of a tube is inflated.

Inner tube films must therefore comply with the toughest requirements made on their mechanical properties such as tear strength (propagation), tensile strength, elongation at break, splicing tendency, impact strength or puncture resistance. In this regard, the PE/PA or PE/AP/PA films used nowadays in the state of the art as inner tube films can still be improved for extra safety.

It is the task of this invention to provide a multilayered film that complies with the strict requirements made on its mechanical stability. Furthermore, it is the task of the invention to suggest the corresponding uses for such a multilayered film.

This task is solved by the multilayered film according to claim 1.

In the multilayered film according to the invention, there is in at least one ethylene-(meth)acrylate copolymer at least one adhesive promoter layer and/or an additional layer that can be functionalized (also known as “modified”). Its proportional weight expressed in percent by weight of the at least one ethylene-(meth)acrylate copolymer can lie in the range between 0.1 and 100% in the at least one layer. The at least one ethylene-(meth)acrylate copolymer can be an ethylene-methyl acrylate (EMA copolymer), ethylene ethyl acrylate (EEA copolymer), ethylene butyl acrylate (EBA copolymer) or ethylene 2-ethyl hexyl acrylate (ethylene 2-EHA copolymer).

The copolymers mentioned above have high impact strength, high heat resistance and high flexibility even at low temperatures.

The name (meth)acrylate applies comprehensively to monomers or polymers manufactured through polymerization or made of acrylic acid ester or methacrylic acid ester. In other words, the name “ethylene-(meth)acrylate copolymer” stands both for ethylene acrylate copolymers and for ethylene methacrylate copolymers.

Within the meaning of this invention, ethylene(meth)acrylate copolymers are all copolymers formed through (co-)polymerization of ethylene (H₂C═CH₂) with esters of acrylic or methacrylic acid. The esterification of the acrylic or methacrylic acid can occur with all common alcohols having the general structural form R—OH (R=stands for saturated or unsaturated, branched or unbranched, aliphatic or aromatic hydrocarbon having, for example, 1 to 60 C atoms). The chemical structural formula of acrylic acid is H₂C═CH—COOH, the chemical structural formula of methacrylic acid is H₂C═C(CH₃)—COOH. Examples of alcohols are methanol, ethanol, propanol, isopropanol, butanol, isobutanol, pentanol, hexanol, 2-ethyl hexanol, heptanol, octanol, decanol, dodecanol, etc.

However, the at least one ethylene(meth)acrylate copolymer prefers no ionomer and consequently has no chain molecules cross linked through ionic bonds.

If apart from ethylene und(meth)acrylates, one or two additional monomers are polymerized too, we get terpolymers (made up of 3 monomers) or quaterpolymers (made up of 4 monomers). Accordingly, such additional polymerization of the ethylene(meth)acrylate copolymer also falls under the term “functionalization” or modification of the ethylene(meth)acrylate copolymers. In this case, one or several chemical functions can be inserted into the polymer, for example. Thus, ethylene(meth)acrylate polymers are obtained with carboxylic acid when the additional monomer is acrylic or methacrylic acid. Ethylene(meth)acrylate polymers with hydroxyl groups form with hydroxyethyl acrylate, for example, as additional monomer. However, ethylene(meth)acrylate polymers can also be given more chemical functions through grafting. Atypical example is grafting with maleic anhydride (MA), which contributes acid anhydride groups to the polymer.

Ethylene- and (meth)acrylate-based polymers that contain three or more additional monomers are possible too, but their industrial importance is secondary.

The advantages of the invention are especially apparent in the outstanding mechanical properties of the film according to the invention, namely very high elongation at break, low tendency to splice, sturdiness, resistance, puncture resistance and a very high transmission in the 300 to 500 nm wave length range. A bursting of the films is therefore practically impossible.

Specifically, it was determined that the multilayered films are characterized by outstanding mechanical values, particularly owing to their very good elongation at break (determined according to the blow-up testing method described below), without one layer breaking. Preferably, the multilayered film has an elongation until it “splices”, i.e. until the first break in an inner film layer of at least 20% occurs, especially preferable is one of at least 25%, very especially preferable is one of at least 30%. The elongation until breaking is preferably at least 100%, preferably at least 110%, especially preferably at least 120%. The most preferred of all is at least 130% and even at least 140%.

An important magnitude related to elasticity is the so-called “yield point”, i.e. the elongation limit. Until that point is reached, force increases with elongation. Once the yield point has been passed, the film starts flowing, the force starts diminishing with increasing elongation or at least remains constant.

A suitable ethylene(meth)acrylate is, for example, Lucofin 1494H, a chemically modified polyethylene in Form of EBA (ethylene butyl acrylate) grafted with maleic anhydride (MA) made by the German company Lucobit AG. As part of this invention, it is preferably used in an adhesive promoter layer. Another suitable ethylene(meth)acrylate is Lucofin 1400HN Powder, which is a polar copolymer made of ethylene and butyl acrylate with low crystallinity.

Owing to its chemical structure, Lucofin 1400HN Powder is softer and more flexible than ethylene homopolymers of comparable density.

Resins of the brand name Lotader made by the French company Arkema, especially Lotader MAH (maleic anhydride) and Lotader GMA (glycidyl methacrylate), which are terpolymers, can also be used.

Suitable ethylene(meth)acrylates are the copolymer resins marketed by DuPont under the brand name Elvaloy AC. Ethylene butyl acrylates (EBA copolymers) are, for example, AC 3117, Elvaloy AC 3217, Elvaloy AC 3427 and Elvaloy AC 3717. Ethylene ethyl acrylates (EEA copolymers) are, for example, Elvaloy AC 2112, Elvaloy AC 2116, Elvaloy AC 2618 and Elvaloy AC 2615. Ethylene methyl acrylates (EMA copolymers) are, for example, Elvaloy AC 1125, Elvaloy AC 1209, Elvaloy AC 1218 and Elvaloy AC 1224, Elvaloy AC 1330, Elvaloy AC 1609, Elvaloy AC 1820, Elvaloy AC 1913, Elvaloy AC 12024S and Elvaloy AC 15024S.

Various suitable ethylene(meth)acrylates are marketed by BASF under the brand names Lucalen, for example Lucalen A 2710 H, Lucalen A 2910 M. Lucalen A 2910 MQ 47, Lucalen A 2920 M, Lucalen A 2920 M Q 225H, Lucalen A 3110 M, Lucalen A 3110 M Q 244, Lucalen A 3110 M Q 270 and Lucalen A 3120 M.

As has already been explained for some of the commercially available ethylene(meth)acrylate copolymers mentioned above, instead or in addition to grafting with maleic anhydride (MA or MAH), a functionalization or modification of the ethylene(meth)acrylate copolymers through copolymerization with (meth)acrylic acid or glycidyl methacrylate or hydroxyl ethyl acrylate is possible. As a result of this, terpolymers or quaterpolymers are obtained.

Another possible modification of the multilayer film according to the invention is powdering.

It is very preferable if at least one adhesive promoter layer and/or an additional layer contain some or even mostly to wholly the at least one ethylene-(meth)acrylate copolymer mentioned above (in which case both contain typically in the inner tube films for trenchless pipe renovation at least one thermoplastic olefin homo or copolymer, frequently or even mostly). The proportion of the at least one ethylene(meth)acrylate copolymer can preferably be more than 30% by weight in the corresponding layer or layers, preferably more than 75% by weight and up to 100% by weight. Mixtures with conventional adhesive promoters or thermoplastic olefin homo or copolymers (or other substances) in the respective layers are by all means possible.

The multilayered film according to the invention can have a layer structure consisting of three, four, five or more layers, particularly when used as inner tube film in sewer pipe renovation. Here, a three-layered, four-layered, five-layered or even more layered inner tube film can be used, in which case according to the invention in at least one of the layers—except in the homo- and/or copolyamide-based layer or layers or containing one of them—there is at least one ethylene(meth)acrylate copolymer.

A three-layer film according to the invention can have, for example, a layer sequence of PE/AP/PA, a five-layer film, for example, a layer sequence of PE/AP/PA/AP/PE, PA/AP/PE/AP/PE or PA/AP/PE/PE/PE or PA/AP/PA/AP/PE, a seven-layered film, for example, a layer sequence of PE/PE/AP/PA/AP/PE/PE. PA/AP/PE/PE/PE/PE/PE or PA/AP/PA/AP/PE/PE/PE or PA/AP/PA/AP/PA/AP/PE. According to the invention, in one or several of the PE and/or AP layers, there is at least one ethylene(meth)acrylate copolymer, in some embodiments even exclusively (in these cases, however, the abbreviations PE and AP do not refer to the ingredients, but are retained for clarity).

The PA layer(s) can be made of the same or different PA material. PA mixtures re preferred. More details are given below. If there are two mPA layers, an adhesive promoter can be introduced, but it is also possible to work without an adhesive promoter. The use of (conventional) adhesive promoters between two PA layers is preferred.

As already mentioned above, it was surprisingly found out that the multilayered film according to the invention, either in form of a multilayered tubular film (i.e. a multilayered film without sealing seam manufactured through (co-) extrusion, preferably through blown film (co-)extrusion) or of a multilayered film sealed to become a tube, was characterized by very good mechanical properties, particularly by very good elongation at break. When renovating underground pipes, it can therefore resist very well, as inner tube film, the stresses that occur particularly while inflating it in the pipe system. This also applies to the mechanical stresses that the film is exposed to during transportation. It was also found out that the multilayered film used as inner tube film is sufficiently tear resistant if it is peeled off from the resin/carrier system after the resin has cured. Thus, the inner tube film can be peeled off leaving no residues or film fragments in the renovated pipe. In addition, the multilayered film according to the invention is a good barrier against the drying-up of the resin used when used as inner tube film.

The numbering of the layers in the sequence layers under stress, i.e. layer (1), layer (2), . . . , clarifies the order of the various layers. One or more additional layers can be provided between these individual layers, for example between layer (1) and layer (2).

At least one homo- and/or copolyamide is/are suitable for manufacturing the layer (1) of the multilayered film according to the invention. Suitable homo- or copolyamides are preferably selected from the group of thermoplastic aliphatic, partially aromatic or aromatic homo- or copolyamides. These homo- or copolyamides can be manufactured from diamines (e.g. aliphatic diamines with 2-10 carbon atoms, especially hexamethylene diamine, and/or aromatic diamines with 6-10 carbon atoms, especially p-phenylene diamine) and/or from aliphatic dicarboxylic acids and/or aromatic dicarboxylic acids having 6-14 carbon atoms (e.g. adipic acid, terephthalic acid or isoterephthalic acid) and/or from lactams having 4-10 carbon atoms (e.g. from ε-caprolactam).

Preferably, PA 6; PA 11; PA 12; PA 66; PA 6,10; PA 6,12; PA 666, PA 6I, PA 6T or the corresponding co-polymers or mixtures from at least two of the polyamides mentioned are used.

The layer (1) of the multilayered film according to the invention has a layer thickness of 5 μm to 100 μm, especially preferred from 20 μm to 90 μm.

To manufacture the adhesive promoter layers (2) and/or (4), the multilayered film according to claim 1—with or without the use according to the invention of at least one ethylene(meth)acrylate copolymer in these layers (2) and/or (4)—can be used as conventional adhesive promoters unless they consist of ethylene(meth)acrylate copolymer. When a modified thermoplastic polymer is used for the adhesive promoter layers (2) and/or (4), the same olefin homo- or copolymers, in particular, can be used in the same way for the additional first and second layers (3; 5) (see below), but with suitable modification. Preferably, according to the above, at least one modified homo- or copolymer is used, in which case the modification is done with at least one organic acid or at least with a preferably cyclic organic acid anhydride, preferably with maleic anhydride.

The layer thickness of the adhesive promoter layers (2) and/or (4) of the multilayered film according to the invention lies preferably between 1 μm to 30 μm, especially preferably between 2 μm to 20 μm.

To manufacture the layers (3) and/or (5), the multilayered film according to claims 1 and 10 of the invention, it is possible to use—when the corresponding layer is not made 100% from ethylene(meth)acrylate copolymer—at least one thermoplastic olefin homo- or copolymer, for example those having α,β unsaturated olefins with 2-10 carbon atoms. In this case, especially suitable for this are ethylene homopolymers (polyethylenes, PE), preferably LDPE (low density polyethylene in the range of 0.86-0.93 g/cm³), LLDPE (linear low density polyethylene), HDPE (high density polyethylene in the range of 0.94 and 0.97 g/cm³) and mPE (made from PE polymerized with metallocen catalysts), propylene homopolymeres (polypropylene, PP), butylene homopolymers (polybutylene, PB) and isobutylene homopolymers (polyisobutylene, PI) or mixtures from at least two of the polymers mentioned.

The layer thickness of layers (3) and/or (5) of the multilayered film according to the invention is preferable 10 μm to 500 μm, especially preferable from 20 μm to 400 μm, and very especially preferable from 30 μm to 300 μm.

The layer thickness of the individual layers (3) and/or (5) of the multilayered film according to the invention is at least 15% of the total layer thickness of the multilayered film, preferably at least 25% and even better especially from 30% to 60%.

Individual or all layers of the multilayered film according to the invention can contain additives if it is advantageous or necessary, in each case irrespective of one another. They can be chosen from the group comprising antistatic agents, antioxidants, oxygen scavengers, anti-blocking agents, antifogging agents, antimicrobial active ingredients, dyes, color pigments, stabilizers, preferably heat stabilizers, process stabilizers, process aids, fireproofing agents, nucleation agents, crystallization agents, preferably crystal nucleation formers, lubricants, optical brighteners, flexibilization agents, sealing agents, softeners, silanes, separators, fillers, peel additives, waxes, wetting agents, surface-active compounds, preferably surfactants, UV stabilizers and dispersion agents. The amount of additives in the layers can be at least 0.01-20% by weight, preferably at least 0.1-10% by weight (in each case referred to the total weight of an individual layer).

The total layer thickness of the multilayered film according to the invention is preferably from 20 to 2000 μm, especially preferably from 50 to 1500 μm, and even better from 70 to 1000 μm, particularly from 80 to 400 μm.

To use the multilayered film according to the invention advantageously as inner tube film in pipe renovation (see above), it should preferably be transparent, at least partially, to UV radiation, i.e. electromagnetic radiation in a wavelength range from 200 to 400 nm, preferably at least 80% and even better at least 90%. An UV source can then exert a good effect on the carrier material preferably impregnated with reactive resin through the multilayered film according to the invention in order to cure it.

In a preferred embodiment, the multilayered film according to the invention is not only at least partially transparent to UV radiation but—for the same reason as above—moreover at least partially transparent to short wave, visible light (i.e. electromagnetic radiation of a wavelength range from 400 to 500 nm, preferably from 400 to 450), preferably at least 80%, especially preferable at least 90%.

The multilayered film according to the invention can be manufactured as tube film through (co-)extrusion, especially preferably through blown film (co-)extrusion, preferably without sealing seam. Alternately, the multilayered film according to the invention can be obtained in form of a tube film as cast film through cast (co-)extrusion or other flat film. Such films can then be sealed to form a tube. An embossing, stretching, conditioning (reversible take-up of humidity, preferably of water, by a thermoplastic synthetic material such as homo- or copolyamide or the entire multilayered film) and/or imprinting the multilayered film according to the invention can be advantageous. On the other hand, the multilayered film according to the invention is preferably not oriented. The multilayered film according to the invention is preferably transparent.

In accordance with what has been previously mentioned, another object of this invention is the use of the multilayered film according to the invention, preferably in form of a tubular film, as a tube (inner tube film) placed inside of an insertion tube, preferably for renovating underground sewage pipes. When doing so, the multilayered film according to the invention, preferably in the form of a tubular film, allows the curing of a reactive plastic resin or of a carrier material impregnated with reactive plastic resin found between an external one- or multilayered tube (outer tube film) and the internal tube (inner tube film) arranged according to the invention owing to its at least partial penetration of UV radiation.

If there is at least one ethylene(meth)acrylate copolymer in at least one of the adhesive promoter layers of the inner tube film, it is preferably functionalized, for example with maleic anhydride.

The preferred carrier materials are glass fiber fabric, synthetic fiber webs (such as needle felts, for example), fleece and/or non-woven textile products or textiles (such as knit hoses, for example) that in each case are impregnated with at least one unsaturated polyester resin (UP resin) and α,β unsaturated monomers such as styrene, for example. One corresponding example would be glass fiber-reinforced plastics (GFPs). Other resins that could be used apart from UP resins are also EP and VE resins.

The invention is likewise about an insertion tube for insertion in an underground pipe, especially a sewage pipe, for its renovation. The insertion tube comprises a multilayered film according to the invention that is impenetrable to liquids according to claim 1 as internally arranged tube (inner tube film, preferably in form of a tubular film) and an outer tube film impenetrable to liquids (external tubular film) facing the pipe wall. A carrier material that can be cured by UV radiation, preferably glass fiber material that has been preferably impregnated with a reactive, unsaturated resin, is provided between the internally and externally arranged tube. The renovated pipe is formed from this impregnated carrier material after the curing. Once the curing process has been completed, the multilayered film according to the invention arranged inside is inserted or extracted from the sewage pipe preferably lined with carrier material. Alternately, the inner tube film remains inside the renovated pipe. The manufacturing of such insertion tubes has been described in WO 2007/054350 A1 or EP 1 155 256 B1. The at least one layer (1) of the multilayered film according to the invention containing homo- and/or copolyamide is preferably oriented towards the resin, whereas the other layers (2)-(4)—if any—face the pipe's interior.

The external tube film can be one- or multilayered and preferably absorb and/or reflect UV radiation and/or short wave visible light. The outer tube film can be either opaque or at least contact transparent.

Preferably, the one- or multilayered tube film of an insertion tube used as external tube (comprising the inner multilayered film in accordance with claim 1, the resin to be cured and the external tube) of an at least contact-transparent tube film that absorbs UV radiation and/or short wave visible light and/or reflecting tubular film. Such an external tube is described in WO 2010/075946 A1 and DE 10 2010 023 764 A1 in which case this external tube has preferably the ingredients and properties described therein, including the oxygen barrier layer, hydrogen barrier layer or oil barrier layer (preferably containing a homo- or copolyamide).

The multilayered film according to the invention can be used not only for sewage pipe renovation by means of UV- or short wave visible light-curing described above, but also in pipe renovation systems in which the insertion tube (that comprises the multilayered film according to the invention) is thermally cured or in which the inversion process is used. The multilayered film according to the invention can also be used in form of a preliner or of a reinforced and/or calibration film.

A preliner within the meaning of this invention is a film, preferably in the form of an insertion tube or a flat film sealed to form a tube, that is inserted between the sewage pipe wall of the pipe to be renovated and the insertion tube. In this case, the film as preliner fulfills a series of tasks such as, for example, preventing the adherence of the resin to the pipe wall and, for example, preventing the insufficiently cured resin to make contact with dirt and water. Furthermore, the preliner film also prevents the resin from coming out of the sewage pipe system and contaminating the soil and ground water. The preliner film also protects the supplies from excess resin penetration preventing resin stoppers or obstructions to form.

The use of the multilayered film according to the invention as preliner resembles a function as sliding film for the pipe liner to be inserted. Therefore, a use according to the invention of the multilayered film described here also pertains to the use as tubular sliding film in the pipe lining process used in trenchless pipe renovation. In this case, the low coefficient of friction between the sliding film and the external film of the pipe liner is what matters.

The function of a calibration tube is largely that of an inner tube film in the UV-/light-curing glass fiber liner system and is arranged in the same way in a pipe liner as in the inner tube film. Often, the external side of the tube of a calibration tube is connected to a fleece or felt (i.e. when used towards the pipe wall). When a calibration tube is used, an inner tube film can be dispensed with. In this case, resin can also be applied on both sides when the film according to the invention is used as calibration tube. Preferably, the resin in form of a carrier (for example, glass fibers or synthetic felt fibers) impregnated with resin makes contact with the film. Then, the layer(s) of the film according to the invention that can be activated make contact with the resin or with the resin-impregnated carrier material (such as fleece, felt or textile, etc.). In this way, a “pipe-in-pipe” system is obtained.

Apart from being used as inner tube film for pipe liners or other films in trenchless pipe renovation, the multilayered film according to the invention can also be used as film for packaging food (so-called food sector) and non-food products (so-called non-food sector), for example as lid and bottom foil, shrink wrap and skin wrap. Even the use of the multilayered films according to the invention for manufacturing bags or as foil for bag-in boxes is possible. In the food packaging sector, it is preferred when there is at least one ethylene(meth)acrylate copolymer in functionalized or non-functionalized form both in the at least one adhesive promoter layer and in the at least one additional layer.

Last but not least, the multilayered film according to the invention can find a use as protective film (e.g. surface protection film and protection film for protective suits). The same applies to its use as cover foil or agricultural foil. More uses or applications are by all means possible.

### Determination of Elongation at Break

Blow-up tests were carried out to determine the elongation at break of a comparative example and various multilayered films according to the invention that have the form of tubular films. In the case of a multilayered film not present as a tubular film but as a flat film, for example, it is sealed to become a tube in order to determine its elongation at break. The tests done on tubular films were part of the invention.

The test is prepared by hermetically sealing a 5 m long tubular film having the dimensions of 1175 mm to 1180 mm on both ends with two metal disks (so-called packers) with a suitable diameter. To accomplish airtightness, tension straps and commercially available fabric adhesive tape were used, as is customary in such blow-up tests. Pressurized air is guided in one of the two packers through a valve into the tubular film until it bursts. Before that happens, cracks in the layer (known as splices) from the internal film layers become recognizable. From them, a localized bubble starts forming only in the multilayered film, which leads to a break and bursting of the tubular film if the blowing continues. The maximum elongation (indicated in percent) is determined by measuring the maximum external circumference of the tubular film achieved and comparing it with the initial tube diameter. The following formula is used for this:

Maximum elongation at break=[(tube diameter after blowing/initial tube diameter before blowing)−1]·100

The same formula is used for the “film splice”, i.e. the first recognizable tear of a tubular film's layer (without affecting the entire tube):

“Splice”=[(tube diameter after blowing and first recognizable layer tear/initial tube diameter before blowing)−1]·100

### Embodiments

The following examples and comparative examples will be given to explain the invention. They should not be interpreted restrictively.

### I. CHEMICAL CHARACTERIZATION OF THE USED RAW MATERIALS

The polyamides (PA) that can be used for the layer (1) are commercially available polyamides (with the respective brand names in parentheses) of the companies BASF (Ultramid), Lanxess (Durethan), DuPont (Zytel), DSM Engineering Plastics (Akulon, Stanyl), EMS-Chemie (Grilamid, Grivory, Grilon), Evonik (Vestamid, Trogamid), Radici (Radilon, Radiflam, Raditer, Heraform, Heraflex) Rhodia (Technyl, Stabamid), UBE, DSM (Novamid) and Atofina (Rilsan). In the examples presented below, a mixture of 12% Durethan B40 FAM (Lanxess) and 88% Durethan C38 F (Lanxess) was always used as polyamide layer.

An adhesive promoter that is typically used, for example, is Admer NF 498 E, an LDPE of the Mitsui Co. modified with maleic anhydride groups.

The polyolefins that are typically used, for example, are Lupolen 2420 F, an LDPE polymer made by the LyondellBasell Co., and Exceed 1327 CA made by the ExxonMobil Chemical Company, an ethylene copolymer manufactured by means of metallocen catalysis in whose polymerization a hexane as additional co-monomer is used apart from ethylene.

Lucofin 1494H, a chemically modified polyethylene in Form of EBA (ethylene butyl acrylate), grafted with maleic anhydride (MA) made by the German company Lucobit AG was used as en ethylene(meth)acrylate. In this case, it was used in the adhesive promoter layers of the multilayered films according to the invention. Additionally, Lucofin 1400HN Powder, a polar copolymer with low crystallinity made up of ethylene and butyl acrylate, was used. Owing to its chemical structure. Lucofin 1400HN Powder is softer and more flexible than ethylene homopolymers with comparable density. Lucofin 1400HN Powder is supplied as a powder of natural color without dyes and additives. Other usable ethylene(meth)acrylate copolymers have already been listed above. The two substances Lucofin 1494H and Lucofin 1400HN Powder are indicated in bold in the tables shown below.

### II. MANUFACTURING OF THE MULTILAYERED FILMS

The multilayered film of the comparative example 1 (V1) consists of five layers. Even the multilayered films of examples 1-7 (B1-B7) consist in each case of five layers. The individual layers of the multilayered films are very closely adjacent to one another, in each case in the sequence indicated. The multilayered films of comparative example V1 and examples 1-7 (B1-B7) were in each case manufactured as tubular films through blown film co-extrusion.

### III. COMPARATIVE EXAMPLE V1 AND EXAMPLES B1-B7 ACCORDING TO THE INVENTION COMPARATIVE EXAMPLE V1

The layer structure corresponds to one of an inner tube film manufactured by BUERGOFOL GmbH. It is already being used for this application.

| Layer | | Amount in | Thickness in |
|---|---|---|---|
| number | Composition | the layer in % | μm |
| (1) | Durethan C38 F | 88 | 40 |
| | Durethan B40 FAM | 12 | |
| (2) | Adhesion promoter: | 100 | 10 |
| | Admer NF 498 E | | |
| (3) | Lupolen 2420 F | 70 | 65 |
| | Exceed 1327 CA | 30 | |
| (4) | Adhesion promoter: | 100 | 10 |
| | Admer NF 498 E | | |
| (5) | Lupolen 2420 F | 70 | 75 |
| | Exceed 1327 CA | 30 | |
| | | | Total thickness: |
| | | | 200 μm |

### EXAMPLE B1

Structure of an inner tube film with Lucofin 1494H in layers (2) and (4).

| Layer | | Amount in | Thickness in |
|---|---|---|---|
| number | Composition | the layer in % | μm |
| (1) | Durethan C38 F | 88 | 40 |
| | Durethan B40 FAM | 12 | |
| (2) | Lucofin 1494H | 100 | 10 |
| (3) | Lupolen 2420 F | 70 | 65 |
| | Exceed 1327 CA | 30 | |
| (4) | Lucofin 1494H | 100 | 10 |
| (5) | Lupolen 2420 F | 70 | 75 |
| | Exceed 1327 CA | 30 | |
| | | | Total thickness: |
| | | | 200 μm |

### EXAMPLE B2

Structure: Inner tube film with Lucofin 1494H in layers (2) and (4) as well as 100% Lucofin 1400HN Powder in layer (3).

| Layer | | Amount in | Thickness in |
|---|---|---|---|
| number | Composition | the layer in % | μm |
| (1) | Durethan C38 F | 88 | 40 |
| | Durethan B40 FAM | 12 | |
| (2) | Lucofin 1494H | 100 | 10 |
| (3) | Lucofin 1400HN Powder | 100 | 65 |
| (4) | Lucofin 1494H | 100 | 10 |
| (5) | Lupolen 2420 F | 70 | 75 |
| | Exceed 1327 CA | 30 | |
| | | | Total thickness: |
| | | | 200 μm |

### EXAMPLE B3

Structure: Inner tube film with Lucofin 1494H in layers (2) and (4) plus a mixture of 50% Lucofin 1400HN Powder with 50% Lupolen 2420 F in layer (3).

| Layer | | Amount in | Thickness in |
|---|---|---|---|
| number | Composition | the layer in % | μm |
| (1) | Durethan C38 F | 88 | 40 |
| | Durethan B40 FAM | 12 | |
| (2) | Lucofin 1494H | 100 | 10 |
| (3) | Lucofin 1400HN Powder | 50 | 65 |
| | Lupolen 2420 F | 50 | |
| (4) | Lucofin 1494H | 100 | 10 |
| (5) | Lupolen 2420 F | 70 | 75 |
| | Exceed 1327 CA | 30 | |
| | | | Total thickness: |
| | | | 200 μm |

### EXAMPLE B4

Structure: Inner tube film with Lucofin 1494H in layers (2) and (4) plus a mixture of Lucofin 50% 1400HN Powder with 50% Lupolen 2420 F in layers (3) and (5).

| Layer | | Amount in | Thickness in |
|---|---|---|---|
| number | Composition | the layer in % | μm |
| (1) | Durethan C38 F | 88 | 40 |
| | Durethan B40 FAM | 12 | |
| (2) | Lucofin 1494H | 100 | 10 |
| (3) | Lucofin 1400HN Powder | 50 | 65 |
| | Lupolen 2420 F | 50 | |
| (4) | Lucofin 1494H | 100 | 10 |
| (5) | Lucofin 1400HN Powder | 50 | 75 |
| | Lupolen 2420 F | 50 | |
| | | | Total thickness: |
| | | | 200 μm |

### EXAMPLE B5

Structure: Inner tube film with conventional adhesive promoters in layers (2) and (4) plus a mixture of 50% Lucofin 1400HN Powder with 50% Lupolen 2420 F in layer (3).

| Layer | | Amount in | Thickness in |
|---|---|---|---|
| number | Composition | the layer in % | μm |
| (1) | Durethan C38 F | 88 | 40 |
| | Durethan B40 FAM | 12 | |
| (2) | Adhesive promoter: | 100 | 10 |
| | Admer NF 498 E | | |
| (3) | Lucofin 1400HN Powder | 50 | 65 |
| | Lupolen 2420 F | 50 | |
| (4) | Adhesive promoter: | 100 | 10 |
| | Admer NF 498 E | | |
| (5) | Lupolen 2420 F | 70 | 75 |
| | Exceed 1327 CA | 30 | |
| | | | Total thickness: |
| | | | 200 μm |

### EXAMPLE B6

Structure: Inner tube film with conventional adhesive promoters in layers (2) and (4) plus a mixture of 50% Lucofin 1400HN Powder with 50% Lupolen 2420 F in layers (3) and (5).

| Layer | | Amount in | Thickness in |
|---|---|---|---|
| number | Composition | the layer in % | μm |
| (1) | Durethan C38 F | 88 | 40 |
| | Durethan B40 FAM | 12 | |
| (2) | Adhesive promoter: | 100 | 10 |
| | Admer NF 498 E | | |
| (3) | Lucofin 1400HN Powder | 50 | 65 |
| | Lupolen 2420 F | 50 | |
| (4) | Adhesive promoter: | 100 | 10 |
| | Admer NF 498 E | | |
| (5) | Lucofin 1400HN Powder | 50 | 75 |
| | Lupolen 2420 F | 50 | |
| | | | Total thickness: |
| | | | 200 μm |

### EXAMPLE B7

Structure: Inner tube film with conventional adhesive promoters in layers (2) and (4) plus 100% Lucofin 1400HN Powder in layer (3).

| Layer | | Amount in | Thickness in |
|---|---|---|---|
| number | Composition | the layer in % | μm |
| (1) | Durethan C38 F | 88 | 40 |
| | Durethan B40 FAM | 12 | |
| (2) | Adhesive promoter: | 100 | 10 |
| | Admer NF 498 E | | |
| (3) | Lucofin 1400HN Puder | 100 | 65 |
| (4) | Adhesive promoter: | 100 | 10 |
| | Admer NF 498 E | | |
| (5) | Lupolen 2420 F | 70 | 75 |
| | Exceed 1327 CA | 30 | |
| | | | Total thickness: |
| | | | 200 μm |

Results from the blow-up test:

| Example/ | | |
|---|---|---|
| Comparative | | Elongation [%] until |
| example | Splice [%] | bursting |
| B1 | 26.0 | 115.0 |
| B2 | 30.0 | 127.0 |
| B3 | 34.2 | 142.3 |
| B4 | 25.8 | 133.5 |
| B5 | 24.9 | 127.7 |
| B6 | 29.8 | 133.1 |
| B7 | 30.2 | 130.2 |
| V1 | 15.9 | 80.5 |

Observations and evaluations made in the blow-up tests:

The starting point: Two values for the elongation at break in % in a commercially available tubular film, already used as inner tube film for pipe liners (comparative example V1, manufacturer: BUERGOFOL GmbH), namely on the one hand, until the first “splice” (i.e. tear of a film layer) is recognizable and until the film bursts, on the other hand. The first tears of a film layer in comparative example 1 could already be determined with a 15.9% elongation, whereas the film burst with an 80.5% elongation.

Hence, this inner tube film is basically suitable for use as inner tube film for pipe liners, but there is always the danger that its elongation behavior will fail when it is really being inflated.

Example B1 used one ethylene acrylate copolymer, here Lucofin 1494H (an EBA copolymer with maleic anhydride groups), 100% in layers (2) and (4) instead of a usual adhesive promoter as in comparative example V1. The film from example B1 shows markedly higher elongations until the film splices and bursts. Splice occurs only at an elongation of 26.0%, while bursting at an elongation of 115.0%.

In the film from example B2, which corresponds to the film from example B1 but with the difference that an ethylene acrylate copolymer (in this case without additional functional group) was introduced 100% in the middle layer (3) with Lucofin 1400HN Powder, even better elongation values (namely 30% elongation until the first tear of an inner layer, i.e. until film splice occurs) and 127.0% elongation until the film bursts are seen compared to the film of example B1. Comparing the inner tube film known from comparative example V1, the elongation until splicing increases by 14.1%, while the elongation until bursting even increases by 46.5%.

Especially good elongation values until the first tear of a layer or until the film bursts are also found in example B3. The film corresponds to the one used in example B2 but with the difference that a mixture of Lucofin 1400HN Powder was mixed with the usual polyolefin, here LDPE Lupolen 2420 F in a 50/50 ratio in the middle layer (3). With an elongation until splicing of 34.2% and with an elongation of 142.3% until the film bursts, even higher elongation values were observed here. Hence, this film according to the invention is particularly suited for use as inner tube film with insertion tubes (pipe liners) for trenchless sewer pipe renovation. The mechanical properties related to the film's elongation are excellent here.

If, as shown in example B4, a mixture of Lucofin 1400HN Powder is also used in layer (5) with a conventional polyolefin, here LDPE Lupolen 2420 F, in a 50/50 ratio—starting with the film from example B3—the elongation values until the splice occurs (25.6%) or until the film bursts (133.5%) decrease slightly, but are nonetheless quite high and likewise lead to an inert tube film that is outstandingly suitable for the pipe lining process.

Examples B5 to B7 demonstrate the positive effect caused by the addition of ethylene acrylate copolymers that occurs even when these copolymers have no chemical function. Thus, in example B5 a very good elongation until the splice of 24.9% and elongation until the film burst of 127.7% were obtained—compared to comparative example V1—using a mixture consisting of Lucofin 1400HN Powder and a customary polyolefin, here LDPE Lupolen 2420 F, in a 50/50 ratio in layer (3).

Even better elongation values until the film spliced and burst—compared to example 5—were obtained in example 6, in which a mixture was used that consisted of Lucofin 1400FIN Powder mixed with a customary polyolefin, here LDPE Lupolen 2420 F, in each case in a 50/50 ratio. Splice occurred in this case at a 29.8% elongation, the film burst at an elongation of 133.1%.

Example B7 corresponds to example B5 but with the difference that a pure layer of an ethylene acrylate copolymer was used in layer (3) with 100% Lucofin 1400HN Powder. The elongation until the splice was 30.1%, the elongation until the film burst was 130.2%.

Examples B1 to B7 show the significant improvement in elongation among the films according to the invention when ethylene acrylate copolymers are used either by themselves or as mixtures. As a result of that, highly stretchable and durable films are obtained that are recommended for use in a very wide area of application.

The invention is not restricted o the embodiments explained in more detail here. Even embodiments from combinations of the characteristics of the sub-claims are readily possible.

1. Multilayered film, preferably in form of a tubular film, with a layer sequence consisting of at least the following layers:
i. At least one layer (1) containing at least one homo- and/or copolyamide, preferably as one of the external layers,
ii. At least one adhesive promoter layer (2), (4), and
iii. At least one additional layer (3), (5), preferably as one of the external layers,
characterized in that in the at least one adhesive promoter layer (2), (4) and/or the at least one additional layer (3), (5), there is at least one ethylene(meth)acrylate copolymer, in functionalized or non-functionalized form.

2-18. (canceled)
